(19) United States
(12) Patent Application Publication
(10) Pub. No.: US 2012/0175565 A1
(43) Pub. Date: Jul. 12, 2012

(54) POLYMER COATINGS CONTAINING CONDUCTIVE POLYMERS

(75) Inventors: Wilfried Lövenich, Bergisch-Gladbach (DE); Rudolf Hill, Langenfeld (DE)

(73) Assignee: Heraeus Precious Metals GmbH & Co, KG, Goslar (DE)

(21) Appl. No.: 13/387,775

(22) PCT Filed: Aug. 5, 2010
(86) PCT No.: PCT/EP2010/004813

§ 371 Date: Mar. 27, 2012

Related U.S. Application Data
(60) Provisional application No. 61/267,530, filed on Dec. 8, 2009.

(30) Foreign Application Priority Data
Aug. 6, 2009 (DE) 10 2009 036 282.7

(51) Int. Cl. H01B 1/12; H01B 1/14; H01B 1/20; C09D 5/24

(52) U.S. Cl. 252/500

(57) ABSTRACT

The present invention relates to coatings containing conductive polymers and anhydric compounds, to the production and use thereof and also to dispersions for producing coatings of this type.

The present invention relates to coatings containing conductive polymers and anhydric compounds, to the production and use thereof and also to dispersions for producing coatings of this type.

Conductive polymers are becoming increasingly economically important, as polymers have advantages over metals with regard to processability, weight and the targeted setting of properties by chemical modification. Examples of known π-conjugated polymers are polypyrroles, polythiophenes, polyanilines, polyacetylenes, polyphenylenes and poly(p-phenylenevinylenes). Layers made of conductive polymers are widely used in industry.

Conductive polymers are produced chemically or by electrochemical oxidation from precursors for the production of conductive polymers, such as for example optionally substituted thiophenes, pyrroles and anilines and the respective optionally oligomeric derivatives thereof Polymerisation by chemical oxidation, in particular, is widespread, as it can be carried out in a technically simple manner in a liquid medium or on a broad range of substrates.

A particularly important and industrially used polythiophene is poly(ethylene-3,4-dioxythiophene) (PEDOT or PEDT) which is produced by chemical polymerisation of ethylene-3,4-dioxythiophene (EDOT or EDT) and which displays in its oxidised form very high conductivities and is described for example in EP 339 340 A2. An overview of numerous poly(alkylene-3,4-dioxythiophene) derivatives, in particular poly(ethylene-3,4-dioxythiophene) derivatives, the monomer building blocks, syntheses and applications thereof is provided by L. Groenendaal, F. Jonas, D. Freitag, H. Pielartzik & J. R. Reynolds, Adv. Mater. 12, (2000) pp. 481-494.

Dispersions of PEDOT with polystyrene sulphonic acid (PSSA) have become particularly industrially important. Transparent, conductive films can be produced from these dispersions; such films have found a large number of applications. However, certain areas of use remain as yet untapped, as both the conductivity and the transmission of the layers produced from PEDOT-PSSA is still too low. Layers made of indium tin oxide (ITO) are distinguished for example by a conductivity of greater than 5,000 S/cm and surface resistances of between 5 and 20 ohms per square (ohms/sq) are achieved with 90% transmission.

The use of additives to increase conductivity in conductive polymers was described for the first time by Mac Dairmid and Epstein (Synthetic Metals 65, (1994), 103-116). Additives of this type are also described as conductivity additives. Mac Dairmid and Epstein added m-cresol as a conductivity additive to the conductive polymer polyaniline and obtained a marked rise in conductivity. Nevertheless, the described conductivities of up to 190 S/cm are not yet sufficient.

In 2002 J. Y. Kim et al. (Synthetic Metals, 126, 2002, pp. 311-316) described how the conductivity of a PEDT/PSSA film can be greatly increased as a result of the use of polar high boilers. The addition of dimethyl sulphoxide (DMSO) to a PEDOT/PSSA dispersion allowed the conductivity to be increased by two orders of magnitude, from 0.8 S/cm to 80 S/cm. However, even a conductivity of 80 S/cm is not yet sufficient to replace ITO, for example.

Ouyang et al. (Polymer, 45, (2004), pp. 8443-8450) published a list of additives allowing the conductivity of PEDOT:PSSA to be increased. The highest conductivity described in this publication, of 200 S/cm, is achieved as a result of the addition of ethylene glycol.

In JP 2007-119548 the use of dicarboxylic acid derivatives in combination with PEDOT:PSSA was tested. For this purpose, PSSA was firstly dialysed three times. Subsequently, EDT was polymerised in the presence of this PSSA and the PEDOT:PSSA complex produced was dialysed a further six times. Finally, the product produced was mixed with various dicarboxylic acids. In this case, conductivities of 770 S/cm and 1,473 S/cm respectively were found for mixtures with thiodiacetic acid, depending on the concentration thereof. Conductivities of 290 S/cm and 596 S/cm respectively were found for mixtures with diglycolic acid, depending on the concentration thereof. Drawbacks of this procedure include on the one hand the complex synthesis of the PEDOT:PSSA with multiple dialysis steps; on the other hand, the measurement of the specific conductivity is not described in detail. A further drawback is the fact that compounds of this type can eliminate water when heated.

In JP 2006-328276 the conductivity of an PEDOT/PSSA dispersion is increased as a result of the use of succinimide, allowing conductivities of from 200-1,000 S/cm to be achieved. However, succinimide is of only limited suitability for producing transparent conductive layers, as it is distinguished by a melting point of from 123-135° C. and a boiling point of from 285-290° C. Under conventional drying conditions of from 100-200° C., succinimide, in contrast to other conductivity additives such as for example dimethyl sulphoxide, therefore remains in the final conductive film, where it forms crystalline regions, leading to clouding of the film. This procedure is therefore also not suitable for producing transparent, highly conductive layers.

WO 2009/030615 A1 describes a synthesis of PEDOT:PSSA dispersions using vacuum. After the addition of DMSO as a conductivity additive, conductivities of 704 S/cm were achieved; the layers obtained were clear. Nevertheless, these conductivities are also not sufficient in order to replace ITO, for example.

There was thus still a demand for transparent coatings having higher conductivity values than the known coatings and also for suitable dispersions for producing coatings of this type.

The object of the present invention thus consisted in providing transparent coatings of this type with higher conductivity values and also suitable dispersions for the production thereof. This invention does not distinguish between the terms “dispersion” and “solution”, i.e. they are regarded as being synonyms.

It has surprisingly been found that dispersions containing at least one conductive polymer and at least one anhydric compound are suitable for producing transparent coatings having higher conductivity values.

The subject matter of the present invention is thus a dispersion comprising at least one conductive polymer, at least one counterion and at least one dispersing agent D), characterised in that the mixture comprises at least one anhydric compound of general formula (I)

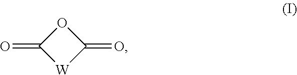

wherein W represents an optionally substituted organic radical with 0-80 carbon atoms.

Within the scope of the invention, the term “an organic radical R” refers to a compound which contains 0 to 80 carbon atoms and is composed for example of one or more of the following groups, wherein individual groups can also occur repeatedly in the radical. The groups in the radical R include ether, sulphone, sulpholane, sulphide, amine, ester, carbonate, amide, imide, aromatic groups—in particular phenylene, biphenylene and naphthalene—and also aliphatic groups, in particular methylene, ethylene, propylene and isopropylidene. The aromatic and aliphatic groups can additionally be substituted. The substituents can be selected from the group consisting of alkyl, preferably C₁-C₂₀ alkyl; cycloalkyl, preferably a C₃-C₁₂ cycloalkyl; an aryl, preferably a C₆-C₁₄ aryl, a halogen, preferably Cl, Br or J; ether, thioether, disulphide, sulphoxide, sulphone, sulphonate, amino, aldehyde, keto, carboxylic acid ester, carboxylic acid, carbonate, carboxylate, phosphonic acid, phosphonate, cyano, alkylsilane and alkoxysilane groups and also carboxylamide groups.

Preferred anhydric compounds within the scope of this invention are compounds of general formula (Ia)

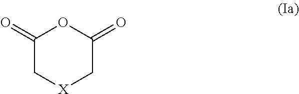

wherein X represents S, O or NH, preferably O.

The proportion of compounds of general formula (I) or (Ia) in the dispersion is 0.001 to 40 per cent by weight (% by weight); preferably, the proportion is 0.1 to 10% by weight, and particularly preferably the proportion is 0.2 to 5% by weight based on the weight of the total dispersion.

The compounds of general formula (I) and (Ia) are commercially available.

Conductive polymers may within the scope of the invention be preferably optionally substituted polypyrroles, optionally substituted polyanilines or optionally substituted polythiophenes. It may also be the case that mixtures of two or more of these conductive polymers are used.

Preferred conductive polymers are optionally substituted polythiophenes comprising repeating units of general formula (II),

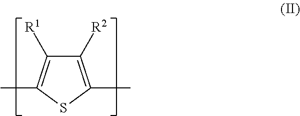

wherein
R¹ and R² independently of each other each represent H, an optionally substituted C₁-C₁₈ alkyl radical or an optionally substituted C₁-C₁₈ alkoxy radical, or
R¹ and R² together represent an optionally substituted C₁-C₈ alkylene radical, an optionally substituted C₁-C₈ alkylene radical, wherein one or more C atom(s) can be replaced by one or more identical or different heteroatoms selected from O or S, preferably a C₁-C₈ dioxyalkylene radical, an optionally substituted C₁-C₈ oxythiaalkylene radical or an optionally substituted C₁-C₈ dithiaalkylene radical, or an optionally substituted C₁-C₈ alkylidene radical, wherein optionally at least one C atom can be replaced by a heteroatom selected from O or S.

In further preferred embodiments, polythiophenes comprising repeating units of general formula (II) are those comprising repeating units of general formula (II-a) and/or of general formula (II-b)

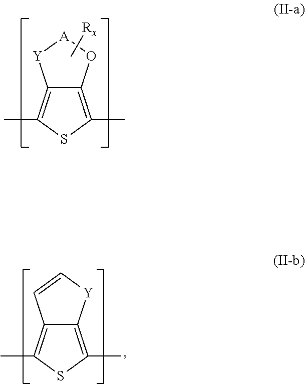

wherein
A represents an optionally substituted C₁-C₅ alkylene radical, preferably an optionally substituted C₂-C₃ alkylene radical,
Y represents O or S,
R represents a linear or branched, optionally substituted C₁-C₁₈ alkyl radical, preferably linear or branched, optionally substituted C₁-C₁₄ alkyl radical, an optionally substituted C₅-C₁₂ cycloalkyl radical, an optionally substituted C₆-C₁₄ aryl radical, an optionally substituted C₇-C₁₈ aralkyl radical, an optionally substituted C₁-C₄ hydroxyalkyl radical or a hydroxyl radical,
x represents an integer from 0 to 8, preferably 0, 1 or 2, particularly preferably 0 or 1, and
if a plurality of radicals R are bound to A, the radicals may be the same or different.

General formula (II-a) is to be understood in such a way that the substituent R can be bound x times to the alkylene radical A.

In still further preferred embodiments, polythiophenes comprising repeating units of general formula (II) are those comprising repeating units of general formula (II-aa) and/or of general formula (II-ab)

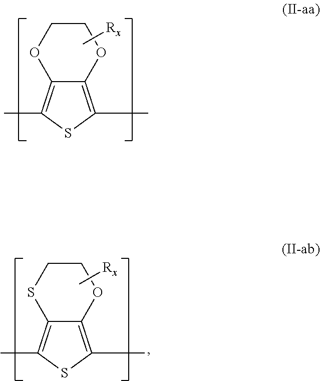

wherein
R has the above-mentioned meaning and x represents an integer from 0 to 4, preferably 0, 1 or 2, particularly preferably 0 or 1.

General formulae (II-aa) and (II-ab) are likewise to be understood in such a way that the substituent R can be bound x times to the ethylene radical.

In still further preferred embodiments, polythiophenes comprising repeating units of general formula (II) are those comprising polythiophenes of general formula (II-a) and/or of general formula (II-b)

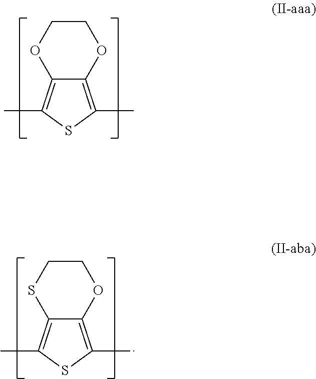

Within the scope of the invention, the prefix “poly” is to be understood as meaning that more than one identical or different repeating units are contained in the polythiophene. The polythiophenes contain in total n repeating units of general formula (I), wherein n may be an integer from 2 to 2,000, preferably 2 to 100. The repeating units of general formula (II) may each be the same or different within a polythiophene. Polythiophenes each comprising identical repeating units of general formula (II) are preferred.

At the end groups, the polythiophenes preferably each carry H.

In particularly preferred embodiments, the polythiophene with repeating units of general formula (II) is poly(3,4-ethylenedioxythiophene), poly(3,4-ethyleneoxythiathiophene) or poly(thieno[3,4-b]thiophene), i.e. a homopolythiophene made up of repeating units of formula (II-aaa), (II-aba) or (II-b), wherein, in the formula (II-b), Y in this case represents S.

In further particularly preferred embodiments, the polythiophene with repeating units of general formula (II) is a copolymer made up of repeating units of formulae (II-aaa) and (II-aba), (II-aaa) and (II-b), (II-aba) and (II-b) or (II-aaa), (II-aba) and (II-b), copolymers made up of repeating units of formulae (II-aaa) and (II-aba) and also (II-aaa) and (II-b) being preferred.

C₁-C₅ alkylene radicals A are within the scope of the invention methylene, ethylene, n-propylene, n-butylene or n-pentylene; C₁-C₈ alkylene radicals are in addition n-hexylene, n-heptylene and n-octylene. C₁-C₈ alkylidene radicals are within the scope of the invention the above-cited C₁-C₈ alkylene radicals containing at least one double bond. C₁-C₈ dioxyalkylene radicals, C₁-C₈ oxythiaalkylene radicals and C₁-C₈ dithiaalkylene radicals represent within the scope of the invention the C₁-C₈ dioxyalkylene radicals, C₁-C₈ oxythiaalkylene radicals and C₁-C₈ dithiaalkylene radicals corresponding to the above-cited C₁-C₈ alkylene radicals. C₁-C₁₈ alkyl represents within the scope of the invention linear or branched C₁-C₁₈ alkyl radicals such as for example methyl, ethyl, n- or isopropyl, n-, iso-, sec- or tert-butyl, n-pentyl, 1-methyl butyl, 2-methyl butyl, 3-methyl butyl, 1-ethyl propyl, 1,1 -dimethyl propyl, 1,2-dimethyl propyl, 2,2-dimethyl propyl, n-hexyl, n-heptyl, n-octyl, 2-ethyl hexyl, n-nonyl, n-decyl, n-undecyl, n-dodecyl, n-tridecyl, n-tetradecyl, n-hexadecyl or n-octadecyl, C₃-C₁₂ cycloalkyl represents C₃-C₁₂ cycloalkyl radicals, such as cyclopropyl, cyclopentyl, cyclohexyl, cycloheptyl, cyclooctyl, cyclononyl or cyclodecyl, C₆-C₁₄ aryl represents C₆-C₁₄ aryl radicals such as phenyl or naphthyl, and C₇-C₁₈ aralkyl represents C₇-C₁₈ aralkyl radicals such as for example benzyl, o-, m-, p-tolyl, 2,3-, 2,4-, 2,5-, 2,6-, 3,4-, 3,5-xylyl or mesityl. C₁-C₁₈ alkoxy radicals represent within the scope of the invention the alkoxy radicals corresponding to the above-cited C₁-C₁₈ alkyl radicals and C₁-C₄ hydroxyalkyl represents within the scope of the invention preferably an above-cited C₁-C₄ alkyl radical which is substituted with one or more, but preferably one hydroxy group. The foregoing list serves to describe the invention by way of example and is not to be regarded as being complete.

The optionally further substituents of the foregoing radicals may be numerous organic groups, for example alkyl, cycloalkyl, aryl, halogen, ether, thioether, disulphide, sulphoxide, sulphone, sulphonate, amino, aldehyde, keto, carboxylic acid ester, carboxylic acid, carbonate, carboxylate, cyano, alkylsilane and alkoxysilane groups and also carboxylamide groups.

The substituents for the other conductive polymers, polyaniline or polypyrrole, may for example be the above-cited radicals A and R and/or the further substituents of the radicals A and R. Unsubstituted polyanilines and polypyrroles are preferred.

The solids content of optionally substituted conductive polymer, in particular of an optionally substituted polythiophene comprising repeating units of general formula (II), is in the dispersion between 0.05 and 20.0 per cent by weight (% by weight), preferably between 0.1 and 5.0% by weight, particularly preferably between 0.3 and 4.0% by weight.

The scope of the invention includes all the foregoing and following, general radical definitions, parameters and comments, or those mentioned in preferred ranges, with one another, i.e. including between the respective ranges and preferred ranges in any desired combination.

The polythiophenes used as conductive polymers in the dispersions may be neutral or cationic. In preferred embodiments, they are cationic, the term “cationic” relating only to the charges on the polythiophene main chain. Depending on the substituent on the radicals R, the polythiophenes can carry positive and negative charges in the structural unit, the positive charges being located on the polythiophene main chain and the negative charges being located optionally on the radicals R which are substituted by sulphonate or carboxylate groups. In this case, the positive charges of the polythiophene main chain may be partly or completely saturated by the optionally present anionic groups on the radicals R. Viewed globally, the polythiophenes may in these cases be cationic, neutral or even anionic. Nevertheless, they are all regarded within the scope of the invention as being cationic polythiophenes, as the positive charges on the polythiophene main chain are decisive. The positive charges are not illustrated in the formulae, as their precise number and position cannot be unobjectionably ascertained. The number of positive charges is however at least 1 and at most n, n being the total number of all the repeating units (the same or different) within the polythiophene.

In order to compensate for the positive charge, if this is not already done by the optionally sulphonate or carboxylate-substituted and thus negatively charged radicals R, the cationic polythiophenes require anions as counterions.

Counterions may be monomeric or polymeric anions, the latter being referred to hereinafter also as polyanions.

The monomeric anions used are for example those of C₁-C₂₀ alkane sulphonic acids, such as methane, ethane, propane, butane or higher sulphonic acids such as dodecane sulphonic acid, of aliphatic perfluorosulphonic acids, such as trifluoromethane sulphonic acid, perfluorobutane sulphonic acid or perfluoroctane sulphonic acid, of aliphatic C₁-C₂₀ carboxylic acids such as 2-ethylhexylcarboxylic acid, of aliphatic perfluorocarboxylic acids, such as trifluoroacetic acid or perfluorooctanoic acid, and of aromatic sulphonic acids optionally substituted by C₁-C₂₀ alkyl groups such as benzene sulphonic acid, o-toluene sulphonic acid, p-toluene sulphonic acid or dodecyl benzene sulphonic acid and of cycloalkane sulphonic acids such as camphor sulphonic acid or tetrafluoroborates, hexafluorophosphates, perchlorates, hexafluoroantimonates, hexafluoroarsenates or hexachloroantimonates. Preferred monomeric anions are the anions of p-toluene sulphonic acid, methane sulphonic acid or camphor sulphonic acid.

Polymeric anions are preferred over monomeric anions, as they contribute to the formation of films and lead, on account of their size, to thermally stabler electrically conductive films. However, the dispersions can also contain monomeric anions in addition to the polymeric anions.

Polymeric anions may in this case be for example anions of polymeric carboxylic acids, such as polyacrylic acids, polymethacrylic acid or polymaleic acids, or polymeric sulphonic acids, such as polystyrene sulphonic acids and polyvinyl sulphonic acids. These polycarboxylic and polysulphonic acids may also be copolymers of vinyl carboxylic and vinyl sulphonic acids with other polymerisable monomers, such as acrylic acid esters and styrene. The combination of the polycation and polyanion is also referred to as a polycation-polyanion complex.

Preferably, the dispersions according to the invention contain as the counterion at least one anion of a polymeric carboxylic or sulphonic acid. A particularly preferred polymeric anion is the anion of polystyrene sulphonic acid (PSSA).

The molecular weight of the polyacids supplying the polyanions is preferably 1,000 to 2,000,000, particularly preferably 2,000 to 500,000. Polyacids or the alkali salts thereof are commercially available, for example polystyrene sulphonic acids and polyacrylic acids, or else can be produced using known methods (see for example Houben Weyl, Methoden der organischen Chemie, Vol. E 20 Makromolekulare Stoffe, Part 2, (1987), pp. 1141 et seq.).

The total proportion of the conductive polymer, in particular the optionally substituted polythiophenes containing repeating units of general formula (II), and the counterion, in particular the polymeric anion, is in the dispersion for example between 0.05 and 10% by weight, preferably between 0.1 and 5% by weight based on the total weight of the dispersion.

The dispersion according to the invention can contain the conductive polymer, in particular the optionally substituted polythiophene comprising repeating units of general formula (II), and the counterion, in particular the polymeric anion, at a ratio by weight of from 1:0.3 to 1:100, preferably from 1:1 to 1:40, particularly preferably from 1:2 to 1:20 and exceedingly preferably from 1:2 to 1:15. The weight of the conductive polymer corresponds in this case to the weighed-in portion of the monomers used, assuming that complete reaction takes place during the polymerisation.

The dispersions according to the invention can comprise one or more dispersing agents D).

Examples of dispersing agent D) include the following solvents: aliphatic alcohols such as methanol, ethanol, i-propanol and butanol; aliphatic ketones such as acetone and methyl ethyl ketone; aliphatic carboxylic acid esters such as acetic acid ethyl ester and acetic acid butyl ester; aromatic hydrocarbons such as toluene and xylene; aliphatic hydrocarbons such as hexane, heptane and cyclohexane; chlorinated hydrocarbons such as dichloromethane and dichloroethane; aliphatic nitriles such as acetonitrile, aliphatic sulphoxides and sulphones such as dimethyl sulphoxide and sulpholane; aliphatic carboxylic acid amides such as methylacetamide, dimethylacetamide and dimethylformamide; aliphatic and araliphatic ethers such as diethyl ether and anisole; glycols such as ethylene glycol. Furthermore, water or a mix of water with the aforementioned organic solvents can also be used as the dispersing agent.

Preferred dispersing agents D) are water or other protic solvents such as alcohols, for example methanol, ethanol, i-propanol and butanol, and also mixtures of water with these alcohols; water is a particularly preferred solvent.

The dispersion according to the invention can additionally comprise at least one polymeric binding agent. Suitable binding agents are polymeric, organic binders, for example polyvinyl alcohols, polyvinylpyrrolidones, polyvinyl chlorides, polyvinyl acetates, polyvinyl butyrates, polyacrylic acid esters, polyacrylic acid amides, polymethacrylic acid esters, polymethacrylic acid amides, polyacrylonitriles, styrene/acrylic acid esters, vinyl acetate/acrylic acid ester and ethylene/vinyl acetate copolymers, polybutadienes, polyisoprenes, polystyrenes, polyethers, polyesters, polycarbonates, polyurethanes, polyamides, polyimides, polysulphones, melamine formaldehyde resins, epoxy resins, silicone resins or celluloses.

The dispersion can additionally comprise adhesion promoters such as for example organofunctional silanes or the hydrolysates thereof, for example 3-glycidoxypropyl trialkoxysilane, 3-aminopropyl triethoxysilane, 3-mercaptopropyl trimethoxysilane, 3-methacryloxypropyl trimethoxysilane, vinyltrimethoxysilane or octyltriethoxysilane.

The proportion of the polymeric binder in the dispersion according to the invention is 0.1-90% by weight, preferably 0.5-30% by weight and most particularly preferably 0.5-10% by weight, based on the total weight of the dispersion.

The dispersion can furthermore comprise additional conductivity additives L). Conductivity additives L) of this type include for example ether group-containing compounds, such as for example tetrahydrofuran; lactone group-containing compounds such as γ-butyrolactone, γ-valerolactone; amide or lactam group-containing compounds such as caprolactam, N-methylcaprolactam, N,N-dimethylacetamide, N-methylacetamide, N,N-dimethylformamide (DMF), N-methylformamide, N-methylformanilide, N-methylpyrrolidone (NMP), N-octylpyrrolidone, pyrrolidone; sulphones and sulphoxides, such as for example sulpholane (tetramethylene sulphone), dimethyl sulphoxide (DMSO); sugar or sugar derivatives, such as for example sucrose, glucose, fructose, lactose, sugar alcohols, such as for example sorbitol, mannitol; imides, such as for example succinimide or maleimide; furan derivatives, such as for example 2-furancarboxylic acid, 3-furancarboxylic acid, and/or di- or polyalcohols, such as for example ethylene glycol, glycerol or di- or triethylene glycol and also sulphuric acid. Mixtures of the aforementioned conductivity additives L) can also be used.

Particularly preferably within the scope of this invention, the compound of general formula (I) or (Ia) is used alone or in combination with at least one of the conductivity additives L) such as tetrahydrofuran, N-methylformamide, N-methylpyrrolidone, ethylene glycol, dimethyl sulphoxide, sorbitol or sulphuric acid.

The total proportion of compounds of general formula (I) or (Ia) and at least one conductivity additive L) in the dispersion is 0.001 to 40; preferably the proportion is 0.5 to 20, and particularly preferably the proportion is 1 to 10% by weight based on the weight of the total dispersion.

A further subject matter of the present is a method for producing the dispersion according to the invention comprising the following steps:
a) producing a dispersion containing at least one conductive polymer, at least one counterion and at least one dispersing agent D), the polymerisation being carried out at a pressure which is below atmospheric pressure,
b) adding at least one compound of general formula (I)

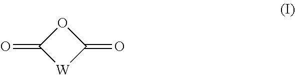

wherein W represents an optionally substituted organic radical with 0-80 carbon atoms.

The above-mentioned method step a) is carried out like the method described in WO 2009/030615 A1. In this case, dispersions of electrically conductive polymers are firstly produced from the corresponding precursors for the production of conductive polymers in the presence of counterions and dispersing agent D) using a pressure which is below atmospheric pressure. This method step is based on the fact that the total pressure in the reaction vessel is reduced before the beginning of the polymerisation. The term “reduced pressure” refers in this case to the fact that the pressure in the reaction vessel is less than the atmospheric pressure which is externally applied to the reaction vessel. An improved variant for producing these dispersions is the use of ion exchanger for removing the inorganic salt content or a part thereof. A variant of this type is described for example in DE-A 196 27 071. The ion exchanger can for example be stirred with the product or the product is conveyed via a column filled with ion exchanger column. The use of the ion exchanger allows low metal contents to be achieved, for example.

In a preferred embodiment of the invention, the polymerisation is carried out at a pressure which is below 800 hPa. In a particularly preferred embodiment, the polymerisation takes place at a pressure which is below 200 hPa and, in a most particularly preferred embodiment, the polymerisation is carried out at a pressure which is below 50 hPa.

The polymerisation is carried out preferably at a temperature in a range of from 0-35° C., particularly preferably at a temperature in a range of from 1-25° C.

At least one anhydric compound of general formula (I) or (Ia) is then added to these dispersions in a method step b) for producing the dispersions according to the invention and mixed, for example while stirring. Optionally, still further dispersing agents, conductivity additives L), organic polymeric binding agents, etc. can be added and mixed, for example while stirring.

The term “precursors for producing conductive polymers”, referred to hereinafter also as precursors, refers for example to corresponding monomers. Mixtures of different precursors can also be used. Suitable monomeric precursors are for example optionally substituted thiophenes, pyrroles or anilines, preferably optionally substituted thiophenes, particularly preferably optionally substituted 3,4-alkylenedioxythiophenes.

Examples of substituted 3,4-alkylenedioxythiophenes include the compounds of general formula (III),

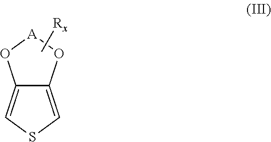

wherein
A represents an optionally substituted C₁-C₅ alkylene radical, preferably an optionally substituted C₂-C₃ alkylene radical,
R represents a linear or branched, optionally substituted C₁-C₁₈ alkyl radical, an optionally substituted C₅-C₁₂ cycloalkyl radical, an optionally substituted C₆-C₁₄ aryl radical, an optionally substituted C₇-C₁₈ aralkyl radical, an optionally substituted C₁-C₄ hydroxyalkyl radical or a hydroxyl radical,
x represents an integer from 0 to 8, preferably 0 or 1 and
   if a plurality of radicals R are bound to A, the radicals may be the same or different.

Most particularly preferred monomeric precursors are optionally substituted 3,4-ethylenedioxythiophenes, in preferred embodiments unsubstituted 3,4-ethylenedioxythiophene.

The substituents for the above-mentioned precursors, in particular for the thiophenes, preferably for 3,4-alkylenedioxythiophenes, may be the radicals mentioned for R for general formula (III).

The substituents for pyrroles and anilines may for example be the above-cited radicals A and R and/or the further substituents of the radicals A and R.

The optionally further substituents of the radicals A and/or the radicals R may be the organic groups mentioned in relation to general formula (II).

Methods for producing the monomeric precursors for producing conductive polymers are known to the person skilled in the art and described for example in L. Groenendaal, F. Jonas, D. Freitag, H. Pielartzik & J. R. Reynolds, Adv. Mater. 12 (2000) 481-494 and the literature cited therein.

The dispersions according to the invention are ideal for producing electrically conductive coatings.

A further subject matter of the present are thus electrically conductive coatings which can be obtained from the dispersions according to the invention.

For producing the coatings according to the invention, the dispersions according to the invention are for example applied using known methods, for example by spin coating, impregnation, pouring, dropping-on, injection, spraying-on, doctoring-on, brushing or imprinting, for example inkjet, screen, gravure, offset or pad printing, to a suitable underlay at a wet film thickness of from 0.5 μm to 250 μm, preferably at a wet film thickness of from 2 μm to 50 μm and subsequently dried at at least a temperature of from 20° C. to 200° C.

The coatings according to the invention surprisingly display conductivities of more than 1,000 S/cm.

The following examples serve to describe the invention by way of example and are not to be interpreted as entailing any limitation.

### EXAMPLES

### Example 1

### Reference Example

### Production of PEDOT:PSSA Under Vacuum and also using DMSO or Thiodiacetic Acid as Conductivity Additives

A 3 litre stainless steel kettle was equipped with a stirrer, a ventilation valve on the upper lid, a closable material inlet on the upper lid, a ventilation valve on the bottom and a temperature-control jacket with a connected thermostat. 2,100 g of water, 500 g of polystyrene sulphonic acid solution (5.0%), 5.6 g of a 10% iron (III) sulphate solution and also 23.7 g of sodium peroxodisulphate were placed into the reaction vessel. The stirrer rotated at 50 rpm. The temperature was set to 45° C. and the internal pressure in the kettle was reduced to approx. 100 hPa. The temperature was kept at 45° C. for 1 hour (h). Subsequently, the temperature was reduced to 13° C. As a result, the pressure decreased to approx. 25 hPa. Subsequently, the equipment was ventilated and 10.13 g of ethylenedioxythiophene (Clevios™ M V2, H. C. Starck GmbH, Goslar) were added via the material inlet. The material inlet was closed and the internal pressure of the reaction vessel was reduced to 30 hPa again with the aid of the vacuum pump. The reaction was now carried out for 23 h under this reduced pressure at 13° C. After conclusion of the reaction, the reaction vessel was ventilated and the mixture was transferred to a plastics material cup and 500 ml of a cation exchanger (Lewatit S100 H, Lanxess AG) and 290 ml of an anion exchanger (Lewatit MP 62, Lanxess AG) were added in order to remove inorganic salts. The mixture was stirred for 6 h and the Lewatit was filtered out. Finally, the mixture was passed through a 10 μm filter. The dispersion obtained had a solids content of 1.23%.

Blending with DMSO and Determining the Conductivity:

19 g of this dispersion were mixed with 1 g of dimethyl sulphoxide (DMSO). 3 ml of the mixture were applied to a glass substrate using a 24 μm wet film doctor blade. Afterwards, the substrate coated in this way was dried on a heating plate for 15 minutes (min.) at 130° C. The layer thickness was 202 nm (Tencor, Alphastep 500).

The conductivity was determined by vapour depositing Ag electrodes having a length of 2.5 cm at a distance of 10 mm via a shadow mask. The surface resistance, which was determined using an electrometer (Keithly 614), was multiplied by the layer thickness in order to obtain the electrical resistivity. The resistivity of the layer was 0.00163 ohms·cm. This corresponds to a conductivity of 613 S/cm. The layers produced in this way are clear.

Blending with Thiodiacetic Acid and Determining the Conductivity:

50 g of the above-described dispersion were mixed with 1 g of thiodiacetic acid. 3 ml of the mixture were applied to a glass substrate using a 24 μm wet film doctor blade. Afterwards, the substrate coated in this way was dried on a heating plate for 30 min at 170° C. The layer thickness was 225 nm (Tencor, Alphastep 500).

The conductivity was determined by vapour depositing Ag electrodes having a length of 2.5 cm at a distance of 10 mm via a shadow mask. The surface resistance, which was determined using an electrometer (Keithly 614), was multiplied by the layer thickness in order to obtain the electrical resistivity. The resistivity of the layer was 0.00171 ohms·cm. This corresponds to a conductivity of 585 S/cm. The layers produced in this way are clear.

### Example 2

### According to the Invention

### Production of PEDOT:PSSA Under Vacuum and also Using Diglycolic Acid Anhydride as a Conductivity Additive

A 3 litre stainless steel kettle was equipped with a stirrer, a ventilation valve on the upper lid, a closable material inlet on the upper lid, a ventilation valve on the bottom and a temperature-control jacket with a connected thermostat. 2,100 g of water, 500 g of polystyrene sulphonic acid solution (5.0%), 5.6 g of a 10% iron (III) sulphate solution, 11.5 g of a 95% sulphuric acid solution and also 23.7 g of sodium peroxodisulphate were placed into the reaction vessel. The stirrer rotated at 50 rpm. The temperature was set to 45° C. and the internal pressure in the kettle was reduced to approx. 100 hPa. The temperature was kept at 45° C. for 1 h. Subsequently, the temperature was reduced to 13° C. As a result, the pressure decreased to approx. 25 hPa. Subsequently, the equipment was ventilated and 10.13 g of ethylenedioxythiophene (Clevios™ M V2, H. C. Starck GmbH, Goslar) were added via the material inlet. The material inlet was closed and the internal pressure of the reaction vessel was reduced to 30 hPa again with the aid of the vacuum pump. The reaction was now carried out for 23 h under this reduced pressure at 13° C. After conclusion of the reaction, the reaction vessel was ventilated and the mixture was transferred to a plastics material cup and 500 ml of a cation exchanger (Lewatit S100 H, Lanxess AG) and 400 ml of an anion exchanger (Lewatit MP 62, Lanxess AG) were added in order to remove inorganic salts. The mixture was stirred for 6 h and the Lewatit was filtered out. Finally, the mixture was passed through a 10 μm filter. The dispersion obtained had a solids content of 1.15%.

2.1: Blending with DMSO and Determining the Conductivity:

19 g of this dispersion were mixed with 1 g of DMSO. 3 ml of the mixture were applied to a glass substrate using a 24 μm wet film doctor blade. Afterwards, the substrate coated in this way was dried on a heating plate for 30 min at 150° C. The layer thickness was 205 nm (Tencor, Alphastep 500).

The conductivity was determined by vapour depositing Ag electrodes having a length of 2.5 cm at a distance of 10 mm via a shadow mask. The surface resistance, which was determined using an electrometer (Keithly 614), was multiplied by the layer thickness in order to obtain the electrical resistivity. The resistivity of the layer was 0.00129 ohms·cm. This corresponds to a conductivity of 774 S/cm. The layers produced in this way are clear.

2.2: Blending with Diglycolic Acid Anhydride and Determining the Conductivity:

19 g of this dispersion were mixed with 1 g of diglycolic acid anhydride (DGA). 3 ml of the mixture were applied to a glass substrate using a 24 μm wet film doctor blade. Afterwards, the substrate coated in this way was dried on a heating plate for 30 min at 150° C. The layer thickness was 210 nm (Tencor, Alphastep 500).

The conductivity was determined by vapour depositing Ag electrodes having a length of 2.5 cm at a distance of 10 mm via a shadow mask. The surface resistance, which was determined using an electrometer (Keithly 614), was multiplied by the layer thickness in order to obtain the electrical resistivity. The resistivity of the layer was 0.00105 ohms·cm. This corresponds to a conductivity of 955 S/cm. The layers produced in this way are clear.

Furthermore, blends were carried out with DGA and DMSO and also DGA, DMSO and sulphuric acid. All the blends were produced as described in the last paragraph, the respective proportion of DGA, DMSO or sulphuric acid being cited in Table 1, and tempered for 30 min at 150° C. The results are summarised in Table 1. All the layers were clear.

TABLE 1

| | Proportion | Proportion | Proportion of | | |
|---|---|---|---|---|---|
| | of | of | sulphuric | | Layer |
| Exam- | DGA | DMSO | acid | Conductivity | thickness |
| ple | [%] | [%] | [%] | [S/cm] | [nm] |
| 2-1 | 0 | 5 | 0 | 774 | 205 |
| 2-2 | 5 | 0 | 0 | 955 | 210 |
| 2-3 | 1 | 4 | 0 | 981 | 250 |
| 2-4 | 0.5 | 4.5 | 0 | 904 | 240 |
| 2-5 | 2.5 | 2.5 | 0 | 955 | 200 |
| 2-6 | 2.5 | 2.5 | 0.01 | 964 | 200 |
| 2-7 | 2.5 | 2.5 | 0.02 | 1,042 | 210 |

As may be seen from the results in Table 1, the addition of DGA as a conductivity additive leads to higher conductivity compared to the known conductivity additive DMSO. A mixture of conductivity additives containing DGA and DMSO or DGA, DMSO and sulphuric acid also leads to higher conductivities.

1-13. (canceled)

14. A dispersion comprising at least one conductive polymer, at least one counterion and at least one dispersing agent D), wherein the mixture comprises at least one compound of general formula (I) 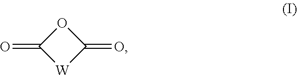
wherein W represents an optionally substituted organic radical with 0-80 carbon atoms.

15. The dispersion according to claim 14, wherein the mixture comprises at least one compound of general formula (Ia) 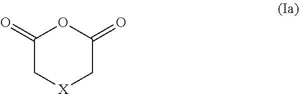
wherein X is S, O or NH.

16. The dispersion according to claim 14, wherein the conductive polymer is optionally substituted polythiophenes comprising repeating units of general formula (I) 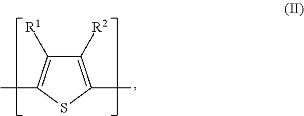
wherein
R¹ and R² independently of each other each represent H, an optionally substituted C₁-C₁₈ alkyl radical or an optionally substituted C₁-C₁₈ alkoxy radical, or
R¹ and R² together represent an optionally substituted C₁-C₈ alkylene radical, an optionally substituted C₁-C₈ alkylene radical, wherein one or more C atom(s) can be replaced by one or more identical or different heteroatoms selected from O or S, an optionally substituted C₁-C₈ oxythiaalkylene radical or an optionally substituted C₁-C₈ dithiaalkylene radical, or an optionally substituted C₁-C₈ alkylidene radical, wherein optionally at least one C atom can be replaced by a heteroatom selected from O or S.

17. The dispersion according to claim 16, wherein
R¹ and R² together represent an optionally substituted C₁-C₈ alkylene radical, an optionally substituted C₁-C₈ dioxyalkylene radical, an optionally substituted C₁-C₈ oxythiaalkylene radical or an optionally substituted C₁-C₈ dithiaalkylene radical, or an optionally substituted C₁-C₈ alkylidene radical, wherein optionally at least one C atom can be replaced by a heteroatom selected from O or S.

18. The dispersion according to claim 16, wherein at least one conductive polymer is a polythiophene comprising repeating units of general formula (II-aaa) and/or of general formula (II-aba)

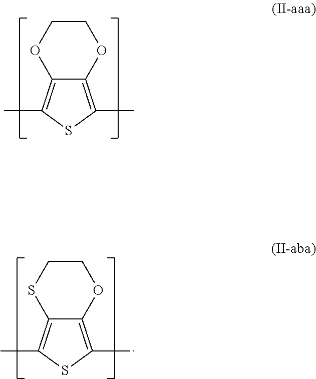

19. The dispersion according to claim 14, wherein at least one counterion is a monomeric or polymeric anion.

20. The dispersion according to claim 19, wherein the polymeric anion is selected from polymeric carboxylic or sulphonic acids.

21. The dispersion according to claim 20, wherein the polymeric anion is polystyrene sulphonic acid.

22. The dispersion according to claim 14, wherein said dispersing agent is water, aliphatic alcohols, aliphatic ketones, aliphatic carboxylic acid esters, aromatic hydrocarbons, aliphatic hydrocarbons, chlorinated hydrocarbons, aliphatic nitriles, aliphatic sulphoxides and sulphones, aliphatic carboxylic acid amides, aliphatic and araliphatic ethers or mixtures of at least two of these.

23. The dispersion according to claim 14, which further comprises as conductivity additive L) are ether group containing compounds, lactone group containing compounds, amide group containing compounds, lactam group containing compounds, sulphones, sulphoxides, sugars, sugar derivatives, sugar alcohols, imides, furan derivatives, dialcohols, polyalcohols or sulphuric acid, or mixtures of at least two of the aforementioned.

24. A process for producing electrically conductive coatings which comprises utilizing the dispersions according to claim 14.

25. An electrically conductive coating which can be obtained from the dispersion according to claim 14.

26. A method for producing the dispersion according to claim 14 comprising the following steps:
a) producing a dispersion comprising at least one conductive polymer, at least one counterion and at least one dispersing agent D), the polymerisation being carried out at a pressure which is below atmospheric pressure,
b) adding at least one anhydric compound of general formula (I) 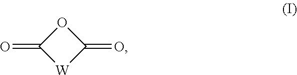
wherein W represents an optionally substituted organic radical with 0-80 carbon atoms.

27. The method according to claim 25, wherein one or more conductivity additives L) are additionally added.
